(19) United States
(12) Patent Application Publication
(10) Pub. No.: US 2026/0064430 A1
(43) Pub. Date: Mar. 5, 2026

(54) METHOD AND SYSTEM FOR OPTIMIZING POWER CONSUMPTION IN SYSTEM ON CHIP DURING WARM BOOT

(71) Applicant: Samsung Electronics Co., Ltd., Suwon-si (KR)

(72) Inventors: Kandala BHARGAVI, Suwon-si (KR); Omkar Ramkaran SINGH, Bengaluru (IN); Prasad Basavaraj DANDRA, Bengaluru (IN); Thejeswara Reddy POCHA, Bengaluru (IN); Tushar VRIND, Bengaluru (IN); Somraj MANI, Bengaluru (IN); Krishnakant Sharad PATIL, Bengaluru (IN); AmolKumar Purushottam JAGTAP, Bengaluru (IN); Seokha HONG, Suwon-si (KR)

(73) Assignee: Samsung Electronics Co., Ltd., Suwon-si, (KR)

(21) Appl. No.: 19/306,473

(22) Filed: Aug. 21, 2025

(30) Foreign Application Priority Data
Aug. 27, 2024 (IN) 202441064672
Aug. 7, 2025 (IN) 202441064672

(51) Int. Cl. G06F 9/4401; G06F 1/28

(52) U.S. Cl. CPC G06F 9/4411; G06F 1/28

(57) ABSTRACT

Provided are a system and a method for optimizing power consumption in system on chip (SoC) during warm boot. The method includes identifying one or more groups of interdependent hardware peripherals on the SoC, an interdependency among at least two interdependent hardware peripherals within each group corresponding to an initialization sequence of the at least two interdependent hardware peripherals, determining power consumed by the one or more groups of interdependent hardware peripherals during the warm boot of the system, creating a subset from among the one or more groups of interdependent hardware peripherals, the power consumed during the warm boot by the one or more groups of interdependent hardware peripherals in the subset being below a power consumption threshold, and generating, based on the subset from among the one or more groups of interdependent hardware peripherals, a file with a load region and an execution region for the subset.

### CROSS-REFERENCE TO RELATED APPLICATION

This application is based on and claims priority under 35 U.S.C. § 119 to Indian Provisional Patent Application No. 202441064672, filed on Aug. 27, 2024, and Indian Patent Application No. 202441064672, filed on Aug. 7, 2025, in the Indian Intellectual Property Office, the disclosure of each of which is incorporated by reference herein in its entirety.

### TECHNICAL FIELD

Various example embodiments of inventive concepts relate to the field of integrated circuits, and more particularly, relate to a system and a method for optimizing (or improving) power consumption in a system on chip (SoC) during warm boot.

### BACKGROUND

Advanced reduced instruction set computing (RISC) machines (ARM) or, more often, RISC-V Central Processing Unit (CPU) architectures serve as the foundation for an embedded System-on-Chip (SoC) (or for a state-of-the-art SoC). The SoC is a collection of hardware components for processing applications, communications, and multimedia. All of the hardware components have the characteristic of being computationally demanding and require (or use) a large quantity of external memory bandwidth. While some hardware components, such as image/multimedia processing, are more throughput-sensitive, others, such as modem/communication reception processing, are more latency-sensitive. For data processing, each component makes use of external memory, including flash and dynamic random-access memory (DRAM). The SoC uses a number of memory hierarchy layers, including Layer 1/Layer 2/Layer 3 (L1/L2/L3) caches and extra on-chip faster memory, including static random-access memory (SRAM), to boost (or improve) overall performance. A group of symmetric multi-processing (SMP) cores clustered together uses the L3 cache as a common cache, while the L1/L2 caches are private to the core.

Multiple clusters share SRAM, which is faster than DRAM access but slower than L3 Cache. In the SoC power-up stage, the SoC boot-up code and SoC security code may reside (or must reside) in SRAM since DRAM may be powered up (or must be powered up) and initialized for usage before it (e.g., DRAM) can be used. Device firmware and software security during the booting process are aided (or greatly aided) by secure boot technologies. SRAM is faster than DRAM due to the use of flip-flops in its design, resulting in a lower refresh rate.

SRAM is used as temporary storage for the functioning of various intellectual properties (IPs) and is widely used in modern SoCs. SRAMs are often referred to as accelerated RAM (XRAM) because SRAMs are considered faster than DRAMs. SRAM/XRAM components are a factor (or a key factor) in determining a chip's performance and yield because SRAM(s) typically occupy approximately 60-70% of the chip's overall space. Parts of the boot code are stored in SRAMs, which also aid in the safe booting of other SoC components.

FIG. 1 illustrates an example diagram depicting an SoC architecture 100, in accordance with conventional art. As shown, the SoC architecture 100 includes an always ON (AON) (or an ON) block 102, a network on chip (NoC) interconnect 104, a double data rate (DDR) memory controller 106, a real-time processor unit (RPU) 108, peripherals 110, and a direct memory access (DMA) 112. The AON block 102 may include an on-chip boot read-only memory (ROM) 102a and a power management controller (PMC) controller 102b, a peripheral protection unit (PPU) RAM 102c, and an extended random-access memory (XRAM) 102d. When the SoC 100 is powered up, the boot process begins at power-on reset (POR) logic where a hardware (HW) reset logic forces the execution to begin from the on-chip boot ROM 102a. The PMC 102b performs initial device booting steps like supplying power or a clock to the SoC architecture 100, handling SoC tamper-proof, and monitoring SoC status using a boot ROM code. Once HW is ready, the PMC 102b performs secondary initialization using PMC 102b firmware. The PMC 102b firmware is present in the PPU RAM 102c. Secondary initialization includes the NoC interconnect 104, the DDR memory controller 106, and the RPU configuration. Once secondary initialization is complete, the PMC controller 102b performs a reset release for the RPU 108. The NoC interconnect 104 is an HW bus component and acts as an interconnect between different bus masters and the DDR memory controller 106 within the SoC architecture 100. The DDR memory controller 106 may be an interface to access a DRAM 114. The DDR memory controller 106 receives commands from different bus masters like a CPU or the DMA 112. The DDR memory controller 106 sends commands to a DRAM physical layer (PHY) 106a. The PHY layer 106a handles timing synchronization of the DRAM interface 114. The PHY layer 106a also handles the sequencing of the commands received from the DDR memory controller 106. The PHY layer 106a may include clock or address or control generation logic, write and read data paths, and initialization logic of the DRAM 114. The PHY layer 106a may also include calibration logic to perform timing and training of read and write data paths. Once the SoC 100 is powered up, the DRAM 114 may be in an operational state before any bus master accesses the DRAM 114. The DRAM 114 may also be in the operational state after performing the initialization procedure. The initialization procedure may include three distinct phases, e.g., a power-up and initialization phase, a calibration phase, and a read or write training phase. The DRAM PHY calibration and training procedure contributes latency (or major latency) on every cold boot and warm boot of the SoC 100. The DRAM PHY calibration and training procedure adds latency (or significant latency) in the SoC Initialization.

The RPU 108 handles low latency protocol stack layers, software-defined transmit and receive chains, and data path interface with an external host, for example supporting universal serial bus (USB) or peripheral component interconnect express (PCIE), or Bluetooth, ZigBee, Wifi, Cellular, etc. The RPU 108 may be connected to the external host and drive other custom digital and analog logic for input and output with peer networking nodes in inter-operability use cases.

The Peripherals 110 and the DMA 112 may include a timer, a universal asynchronous receiver transmitter (UART), the USB, the PCIE, Wifi, cellular, and Bluetooth-related hardware components.

Further, the SoC 100 may enter different sleep modes depending on (or based on) the processing state. The RPU 108 typically supports two sleep modes, e.g., a standby mode and a deep sleep mode. In the standby mode, the core is powered up but the clocks are stopped. The standby mode is entered using a wait-for-interrupt (WFI) or a wait-for-event (WFE) instruction. The WFE or the WFI instruction suspends execution of the RPU 108. Whenever an interruption occurs, the SoC 100 exits from the standby mode. In the deep sleep mode, the core is powered off. Before the RPU 108 enters into power-down mode, the state and context of the RPU 108 should be saved. The deep sleep mode is also referred to as Power Down mode. The interruption can cause the RPU 108 to wake up from deep sleep. This process is referred to as a warm boot. In contrast, a cold boot is carried out when the electronic device boots up for the first time or by turning on the power button of the electronic device.

Accordingly, the process of starting the SoC 100 from a fully powered-off condition is known as cold boot. The SoC 100 may be powered on (or must be powered on), the CPU may be started (or must be powered on), and several components, including the memory (the DRAM 114), cache (SRAMs), other on-chip memory (the XRAM 102d), and the peripherals 110, may be initialized (or must be initialized). A bootloader installs the operating system and launches a user application when the CPU retrieves the user application from the memory and gives control to the user application. Restarting a running SoC without shutting it down (or without fully shutting down the SoC) is known as warm boot. The warm boot is frequently used to fix problems or to check for messages or data that may to be processed (or need to be processed) from outside sources during brief sleep or awakening periods. The CPU and other components maintain their states during the warm boot, enabling a faster boot process compared to a cold boot. However, some components may still need to be reinitialized (or it may be beneficial to reinitiate some components), such as the memory and the cache. The warm boot process typically involves resetting the CPU, initiating a power-on self-test (POST), and scanning/polling for external messages/information or recovering from errors.

FIG. 2 illustrates an example diagram 200 depicting the warm boot-up stages and the cold boot-up stages of the SoC 100, in accordance with conventional art. The SoC 100 may include four cold boot-up stages, and two warm boot stages 206, 208 (e.g., RPU execution stage 206 and RPU 208) as illustrated in FIG. 2. The four cold boot-up stages and the two warm boot stages typically are part of the sleep and wake-up procedure. As shown in FIG. 2, at stage 1, e.g., boot-up stage 202, the PMC 102b hardware detects a power signal (or a valid power signal), and the power-on reset (POR) pin is released to initiate the SoC boot sequence. After the power is applied to the SoC 100, the dedicated PMC 102b hardware jumps to boot initialization in boot ROM and proceeds to stage 2. At stage 2, e.g., boot initialization stage 204, the boot ROM code 102a configures the clock (or the required clock) and power settings to the blocks of the PMC 102b. The boot ROM code 102a also validates the platform firmware, loads the firmware into the PPU RAM 102c for secondary initialization, and proceeds to stage 3. At stage 3, e.g., platform load stage 204, the PMC 102b executes the boot code from the PPU RAM 102c. The PMC 102b performs NoC initialization, the DDR memory configuration or calibration, and the configuration of the RPU 108. The PMC 102b also loads applications from the external ROM to the DRAM 114 and performs a reset of the RPU 108. At stage 4, e.g., RPU execution stage 206, the RPU 108 starts to boot independently from the DRAM 114. Once booting is completed, the initialization of some peripherals (or critical peripherals) among the peripherals 110 and the DMA block 112 is performed and the application is executed. The RPU 108 typically runs a customized real-time operating system (OS) such as Free RTOS to support a fast (or faster) interruption processing. Interrupts are generated for the RPU 108 from the other custom digital and analog logic in the SoC 100 (or required) for handling real-world data blocks. After the RPU 108 execution is completed, and the SoC 100 decides to go into deep sleep, a deep sleep sequence is invoked. For example, HW peripherals 110 are turned off. The wakeup interrupt source is configured, and the SoC 100 enters the warm boot sequence. During the warm boot, the stage 3 (RPU execution stage 206) and the stage 4 (RPU 208) are repeated based on the deep sleep and warm boot interrupt.

Further, as shown in FIG. 2, the PMC 102b performs the reset release of the RPU 108, NOC 104, and the DDR memory controller 106. The application of RPU 108 may be loaded into the DRAM 114 for execution. However, the application cannot be loaded into the DRAM 114 until the initialization of DRAM 114 is completed. The RPU 108 waits for the completion of the DDR memory controller 106 interface and the NoC configuration before the RPU application is started. The initialization and calibration of the DRAM 114 take more time, resulting in a slower boot process for the RPU 108. The increased time consumption impacts power usage, leading to higher power consumption during the warm bootup. Accordingly, it may be beneficial for various existing techniques (in conventional arts) to be directed toward implementing power-saving mechanisms.

For example, one of the existing techniques (in conventional arts) aims to speed up the boot time of electronic devices by introducing a fast boot framework that isolates specific processes from their dependencies and streamlines the current initialization process. According to another technique (in conventional arts), fast boot and shutdown in the electronic devices are performed by optimizing (or improving) the suspend-resume method using improved snapshot imaging. In another technique (in conventional arts), an unsorted block image file system (UBIFS) is used, allowing consumers of the electronic devices to boot up faster than devices with other existing flash file systems. In another existing technique (in conventional arts), a boot loader (or an efficient boot loader) is designed by optimizing (or improving) the effect of altering the software stack on memory usage, application performance, and function availability to enhance the boot time of an embedded system.

The above-discussed techniques (in conventional arts) reduce the boot time associated with the cold boot, but there is currently no method to optimize (or improve) the warm boot process.

Therefore, in view of the above-mentioned problems, it is advantageous to provide an improved method and system that can overcome the above-mentioned problems and limitations.

### SUMMARY

This summary is provided to introduce a selection of concepts, in a simplified format, that are further described in the detailed description of the present specification. This summary is neither intended to identify key or essential (or to identify beneficial) concepts of the present specification, nor it is intended for determining the scope of the present inventive concepts.

Various example embodiments provide a system and a method for optimizing (or improving) power consumption in a system on chip (SoC) during warm boot.

Some example embodiments of inventive concepts provide a method for optimizing power consumption in a system on chip (SoC) during warm boot, the method including identifying one or more groups of interdependent hardware peripherals on the SoC, wherein an interdependency among at least two interdependent hardware peripherals within each group of the one or more groups of interdependent hardware peripherals corresponds to an initialization sequence of the at least two interdependent hardware peripherals, determining power consumed by the one or more groups of interdependent hardware peripherals during the warm boot of the SoC, creating a subset from among the one or more groups of interdependent hardware peripherals, wherein the power consumed during the warm boot by the one or more groups of interdependent hardware peripherals in the subset is below a power consumption threshold, and generating, based on the subset from among the one or more groups of interdependent hardware peripherals, a file with a load region and an execution region for the subset.

Some example embodiments of inventive concepts provide a system for optimizing power consumption in a system on chip (SoC) during warm boot, the system including a memory storing a program of instructions, a processor coupled with the memory, a power management unit coupled to the memory and the processor, wherein the processor is configured to execute the program of instructions to identify one or more groups of interdependent hardware peripherals on the SoC, wherein an interdependency among at least two interdependent hardware peripherals within each group of the one or more groups of interdependent hardware peripherals corresponds to an initialization sequence of the at least two interdependent hardware peripherals, wherein the power management unit is configured to determine power consumed by the one or more groups of interdependent hardware peripherals during the warm boot of the SoC, wherein the processor is further configured to create a subset from among the one or more groups of interdependent hardware peripherals, wherein the power consumed during the warm boot by the at least two interdependent hardware peripherals in the subset is below a power consumption threshold, and generate, based on the subset from among the one or more groups of interdependent hardware peripherals, a file with a load region and an execution region for the subset. Some example embodiments of inventive concepts provide a method of an initialization sequence of a system on chip (SoC), the method including executing, by a power management controller (PMC), a boot read-only memory (ROM) power on reset, loading, by the PMC, platform firmware into a peripheral protection unit (PPU) random-access memory (RAM), and performing, by the PMC, a network-on-chip (NoC) and a double data rate (DDR) configuration and a reset of a real-time processor unit (RPU).

To further clarify the advantages and features of the present inventive concepts, a more particular description of the present specification will be rendered by reference to specific embodiments thereof, which are illustrated in the appended drawings. It is appreciated that these drawings depict typical (or only typical) example embodiments of the present inventive concepts and are therefore not to be considered limiting its scope. The present inventive concepts will be described and explained with additional specificity and detail with the accompanying drawings.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates an example diagram depicting a system on chip (SoC) architecture, in accordance with conventional art;

FIG. 2 illustrates an example diagram depicting the warm boot-up stages and the cold boot-up stages of the SoC, in accordance with conventional art;

FIG. 3 illustrates a schematic diagram depicting an environment for the implementation of a system for optimizing power consumption in the SoC during warm boot, in accordance with some example embodiments;

FIG. 4 illustrates a block diagram depicting a system for optimizing power consumption in the SoC during the warm boot, in accordance with some example embodiments;

FIG. 5 illustrates a flow diagram depicting a method for optimizing power consumption in the SoC during the warm boot, in accordance with some example embodiments; and

FIGS. 6A-6B illustrate an operational flow for optimizing power consumption in the SoC during warm boot, in accordance with some example embodiments.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present inventive concepts. Furthermore, in terms of the construction of example embodiments, one or more components of example embodiments may have been represented in the drawings by conventional symbols, and the drawings may show those specific (or only those specific) details that are pertinent to understanding the some example embodiments of the present inventive concepts so as not to obscure the drawings with details that will be readily apparent to those of ordinary skill in the art having the benefit of the description herein.

### DETAILED DESCRIPTION

For the purpose of promoting an understanding of the principles of the present inventive concepts, reference will now be made to various example embodiments and specific language will be used to describe the same. It will nevertheless be understood that no limitation of the scope of the present inventive concepts is thereby intended, such alterations and further modifications in the illustrated system, and such further applications of the principles of the present inventive concepts as illustrated therein being contemplated as would normally occur to one skilled in the art to which the present specification relates.

It will be understood by those skilled in the art that the foregoing general description and the following detailed description are explanatory of the present inventive concepts and are not intended to be restrictive thereof.

Whether or not a certain feature or element was limited to being used once (or only once), it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.” Reference is made herein to some “example embodiments.” It should be understood that an example embodiment is an example of a possible implementation of any features and/or elements of the present inventive concepts. Some example embodiments have been described for the purpose of explaining one or more of the potential ways in which the specific features and/or elements of the present inventive concepts include uniqueness, utility, and non-obviousness.

Use of the phrases and/or terms including, but not limited to, “a first example embodiment,” “a further example embodiment,” “an alternate example embodiment,” “one example embodiment,” “an example embodiment,” “multiple example embodiments,” “some example embodiments,” “other example embodiments,” “further example embodiment”, “furthermore example embodiment”, “additional example embodiment” or other variants thereof do not necessarily refer to the same example embodiments. Unless otherwise specified, one or more particular features and/or elements described in connection with one or more example embodiments may be found in one example embodiment or may be found in more than one example embodiment, or may be found in all example embodiments, or may be found in no example embodiments. Although one or more features and/or elements may be described herein in the context of a single (or only a single) example embodiment, or in the context of more than one example embodiment, or in the context of all example embodiments, the features and/or elements may instead be provided separately or in any appropriate combination or not at all. Conversely, any features and/or elements described in the context of separate example embodiments may alternatively be realized as existing together in the context of a single embodiment.

Any particular and all details set forth herein are used in the context of some example embodiments and therefore should not necessarily be taken as limiting factors to the present inventive concepts.

The terms “comprises,” “comprising,” “including,” or any other variations thereof, are intended to cover a non-exclusive inclusion, such that a process or method that comprises a list of steps does not include those (or only those) steps but may include other steps not expressly listed or inherent to such process or method. Similarly, one or more devices or sub-systems or elements or structures or components proceeded by “comprises . . . a” or “includes” does not, without more constraints, preclude the existence of other devices or other sub-systems or other elements or other structures or other components or additional devices or additional sub-systems or additional elements or additional structures or additional components.

Embedded devices are powered by batteries, so longer battery life may be a factor (or may be a critical factor) in the success of the embedded devices. In some example embodiments, the present inventive concepts provide optimization (or improvement) techniques for system-on-chip (SoC) and software design to achieve power savings while the embedded device have (or performs) periodic wake-ups from deep sleep, also known as warm boots. For a warm boot (or for an efficient warm boot), some components or domains are kept always ON (or are kept ON) for quick booting, while others are switched OFF or clock-gated, like the dynamic random-access memory (DRAM). Thus, after a warm boot, software implementation may wait (or must wait) for DRAM initialization before starting operations, thereby increasing the system response time. To address this issue, the disclosed techniques utilize accelerated RAM (XRAM) in an always-ON domain (or in an ON domain), for performing selected operations before DRAM initialization completes, like initializing peripheral hardware components during the warm boot sequence.

Some example embodiments of the present inventive concepts will be described below in detail with reference to the accompanying drawings.

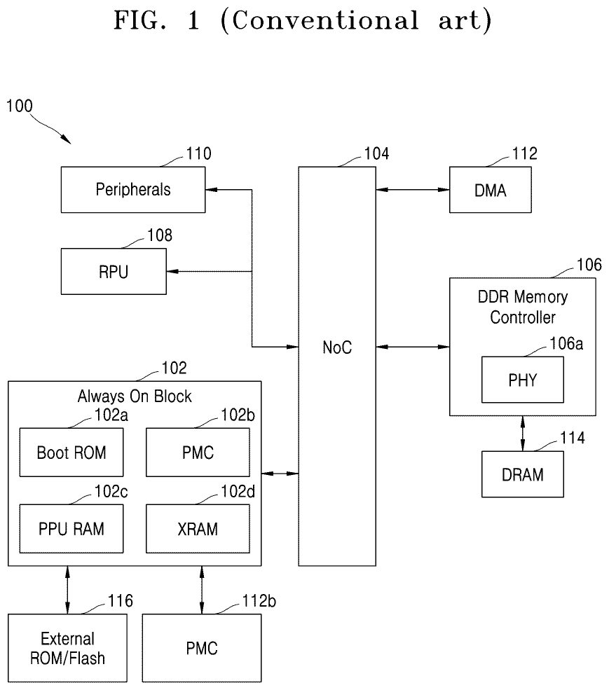

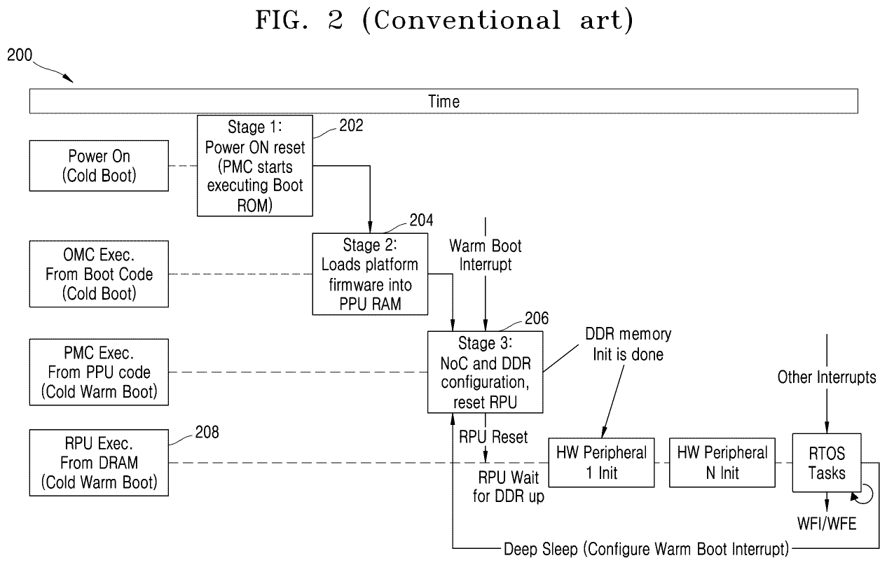

For the sake of clarity, the first digit of a reference numeral of each component of the present specification is indicative of the Figure number, in which the corresponding component is shown. For example, reference numerals starting with the digit “1” are shown at least in FIG. 1. Similarly, reference numerals starting with the digit “2” are shown at least in FIG. 2.

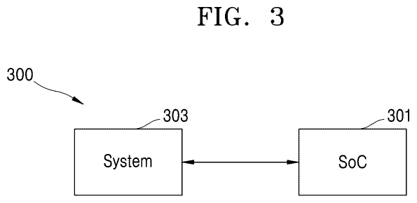

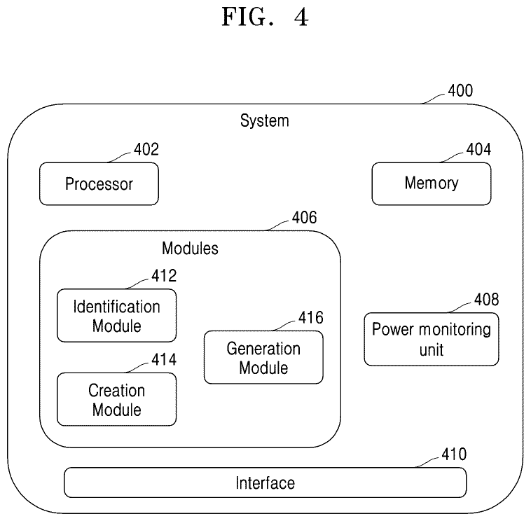

FIG. 3 illustrates a schematic diagram depicting environment 300 for the implementation of a system 303 for optimizing (or improving) power consumption in the SoC during warm boot, in accordance with some example embodiments. As shown in FIG. 3, a SoC evaluation board 301 (also referred to as SoC 301) is connected to the system 303. The SoC 301 may be connected to a power supply (not shown). The system 303 may generate an executable file (also referred to as an image or binary file) (or the system 303 may be used to generate an executable file). This image file may be flashed on the SoC 301 for optimization (or improvement) of the power consumption in the SoC 301 during the warm boot. In some example embodiments, the system 303 may be configured to optimize (or improve) power consumption in the SoC 301 during warm boot, as discussed further below. The system 303 will be explained in detail with reference to FIG. 4.

FIG. 4 illustrates a block diagram depicting a system 400 for optimizing (or improving) power consumption in the SoC during warm boot, in accordance with some example embodiments. In some example embodiments, the system 400 may refer to the system 303 of FIG. 3 The system 400 may include a plurality of components including, but not limited to, a processor 402, a memory 404, a plurality of modules 406, a power management unit 408 (also referred to as the power monitoring unit 408), and an interface 410. The plurality of components of the system 400 may be communicatively coupled with each other.

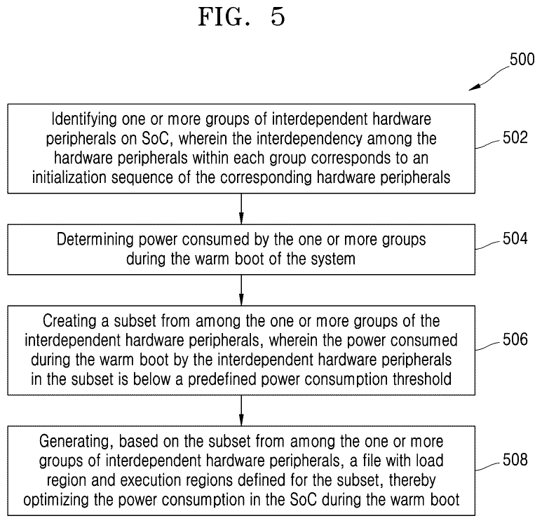

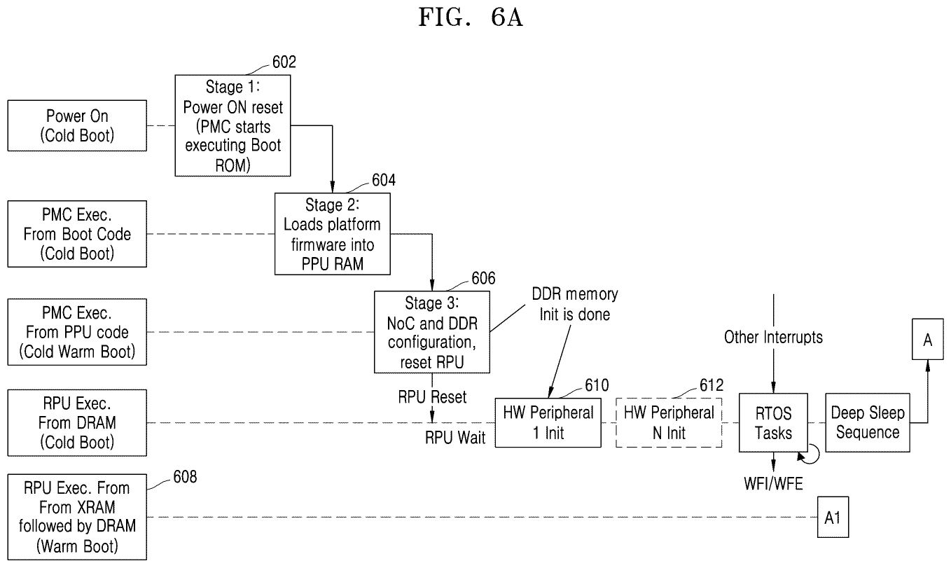

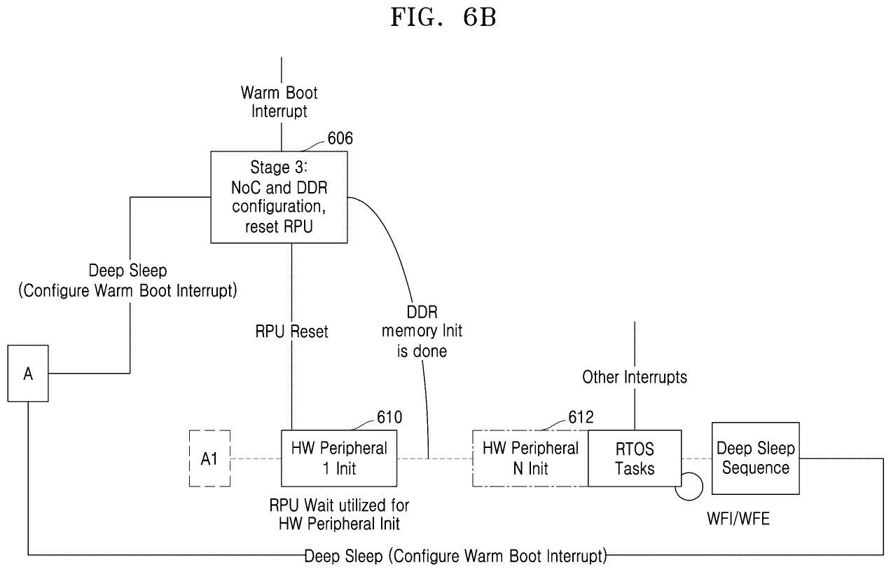

The processor 402 can be (or include) a single processing unit or several units, all of which could include multiple computing units. The processor 402 may be implemented as one or more microprocessors, microcomputers, microcontrollers, digital signal processors, central processing units, state machines, logic circuitries, and/or any devices that manipulate signals based on operational instructions. Among other capabilities, the processor 402 is adapted to fetch and execute computer-readable instructions and data stored in the memory 404. One or a plurality of processors may be a general purpose processor, such as a central processing unit (CPU), an application processor (AP), or the like, a graphics processing (or a graphics-only processing) unit such as a graphics processing unit (GPU), a visual processing unit (VPU), and/or an AI-dedicated (artificial intelligence-dedicated) processor such as a neural processing unit (NPU), but example embodiments are not limited thereto. One or a plurality of processors may control the processing of the input data in accordance with an operating rule (or a predefined operating rule) or an artificial intelligence (AI) model stored in a non-volatile memory and a volatile memory. Further, the working (or operation) of the system 400 will be explained with respect to FIGS. 5-6B. The reference numerals are kept the same in the present specification wherever applicable for ease of explanation.

The memory 404 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes, but example embodiments are not limited thereto. A configuration (or a predefined configuration) may be stored in the memory 404.

The interface 410 may be configured to provide network connectivity and enable communication with paired devices such as the system 400. The network connectivity may be provided via a wireless connection or a wired connection.

The plurality of modules 406 (also referred to as modules 406), amongst other things, may include routines, programs, objects, components, data structures, etc., which may perform particular tasks or implement data types. The modules 406 may also be implemented as signal processor(s), state machine(s), logic circuitries, and/or any other device or component that manipulates signals based on operational instructions, but example embodiments are not limited thereto.

Further, the plurality of modules 406 can be implemented in hardware, instructions executed by a processing unit, or by a combination thereof. The processing unit may comprise a computer, a processor, a state machine, a logic array, or any other suitable devices capable of processing instructions. The processing unit can be a general-purpose processor which executes instructions to cause the general-purpose processor to perform the tasks (or to perform the required tasks) or, the processing unit can be dedicated to performing specific functions (or the required functions). In some example embodiments, the processor 402 via the plurality of modules 406 may be configured to execute machine-readable instructions (software) which perform the working of the system 400 within the scope of the present inventive concepts as described in forthcoming paragraphs. The plurality of modules 406 may include an identification module 412, a power management unit 408, a creation module 414, and a generation module 416. The plurality of modules 406 may include a set of instructions that may be executed according to some example embodiments for optimization (or improvement) of the power consumption in the SoC 301 during the warm boot, for example, as described below in the forthcoming paragraphs in detail in conjunction with FIGS. 5-6B.

FIG. 5 illustrates a flow diagram depicting a method 500 for optimizing (or improving) power consumption in the SoC during the warm boot, in accordance with some example embodiments. As shown, at step 502, the method 500 may include identifying one or more groups of interdependent hardware peripherals on the SoC 301. In some example embodiments, the interdependency among the hardware peripherals (or the interdependency among at least two interdependent hardware peripherals) within each group of the one or more groups of interdependent hardware peripherals on the SoC 301 may correspond to an initialization sequence of the corresponding hardware peripherals (or of the at least two hardware peripherals). For example, the identification module 412 may isolate the hardware peripherals, which may be independent of DRAM data access. In some example embodiments, the identification module 412 may identify one or more independent hardware peripherals that are initialized in an independent manner. The identified one or more hardware peripherals may refer to a hardware peripheral that is not dependent on any other hardware peripheral for initialization. Then, the identification module 412 may exclude the identified one or more independent hardware peripherals while identifying the one or more groups of interdependent hardware peripherals. Accordingly, the one or more groups of the interdependent hardware peripherals may include the hardware peripherals that are dependent on at least one other hardware peripheral for initialization. For example, if there are twelve (12) hardware peripherals, of which four ( ) of these hardware peripherals are independent hardware peripherals. Then, the identification module 412 may identify the rest of the eight (8) hardware peripherals of the twelve (12) hardware peripherals as interdependent hardware peripherals. Thereafter, the identification module 412 may identify the one or more groups of interdependent hardware peripherals among these eight (8) interdependent hardware peripherals such as group 1, group2, . . . , group N. In some example embodiments, the identification module 412 may identify dependencies among the interdependent hardware peripherals and place the interdependent hardware peripherals in the same group. In some example embodiments, to identify the one or more groups of interdependent hardware peripherals, the identification module 412 may determine one or more initialization sequences of the interdependent hardware peripherals in each group. The identification module 412 may determine the one or more initialization sequences using known techniques (e.g., techniques known in conventional arts). Then, the identification module 412 may determine the corresponding initialization time for initializing the corresponding hardware peripherals in each of the one or more initialization sequences. The identification module 412 may then identify the one or more groups of the interdependent hardware peripherals based on the determined corresponding initialization time. For example, the identification module 412 may group the interdependent hardware peripherals in the one or more groups of the interdependent hardware peripherals when (or only when) the corresponding initialization time for initializing the interdependent hardware peripherals in each group is below an initialization time (or below a predefined initialization time) associated with the initialization of a dynamic random access memory (DRAM), e.g., Tₘₑₘ. However, if the initialization time of the interdependent hardware peripherals in a group is more than Tₘₑₘ, then the identification module 412 may identify another candidate group and repeat the procedure until all combinations of groups are profiled (or identified).

Thereafter, at step 504, the method 500 may include determining power consumed by the one or more groups of interdependent hardware peripherals during the warm boot of the SoC 301. In some example embodiments, the power management unit 408 may determine the power consumed by each group of the one or more groups of interdependent hardware peripherals. In some example embodiments, the power management unit 408 may receive the identified one or more groups of interdependent hardware peripherals from the identification module 412. In some example embodiments, the power management unit 408 may determine the power consumed by a combination of groups of the one or more groups of the interdependent hardware peripherals in an optimized (or in an improved) sequence. In some example embodiments, the optimized (or the improved) sequence may refer to a sequence or order in which the one or more groups of interdependent hardware peripherals will be operated. For example, the power management unit 408 may determine the power consumed by group 1 and group 2 or group 2 and group N. In some example embodiments, the power management unit 408 may determine the power consumed using a power monitor (not shown).

Then, at step 506, the method 500 may include creating a subset from among the one or more groups of the interdependent hardware peripherals based on the determined consumed power. For example, the creation module 414 may create an intermediate file with load and execution regions corresponding to the one or more groups of interdependent hardware peripherals. In some example embodiments, a load region may correspond to DRAM, and an execution region may correspond to an extended random-access memory (XRAM). Accordingly, at link time, the function execution addresses of the interdependent hardware peripherals may be mapped to XRAM regions. In some example embodiments, the execution regions may comprise an initialization sequence of each group of the one or more groups of interdependent hardware peripherals. In some example embodiments, the execution regions may comprise an initialization sequence of a combination of the one or more groups of interdependent hardware peripherals. In some example embodiments, after creating the intermediate file, the creation module 414 may generate a binary file corresponding to the intermediate file. Then, the creation module 414 may determine, based on the execution of the binary file, the power consumed by the interdependent hardware peripherals. For example, the creation module 414 may initialize the interdependent hardware peripherals with respect to the initialization sequence to determine the power consumed by the interdependent hardware peripherals. Then, the creation module 414 may create the subset corresponding to either each of the one or more groups of the interdependent hardware peripherals or a combination of the one or more groups of the interdependent hardware peripherals. It should be noted that the power consumed during the warm boot in each group of the one or more groups of the interdependent hardware peripherals or the combination of the one or more groups of the interdependent hardware peripherals may be below a power consumption threshold (or below a predefined power consumption threshold). Further, the creation module 414 may compare the power consumed by each group of the one or more groups of interdependent hardware peripherals with the power consumed by the power consumption threshold (or by the predefined power consumption threshold) and record power metrics comprising the result of the comparison. If the power consumed by a group of interdependent hardware peripherals is below the power consumption threshold, then the creation module 414 may create the subset using that group. However, if the power consumed by any group of the interdependent hardware peripherals is above the power consumption threshold (or above the predefined power consumption threshold), then the creation module 414 may choose another group among the one or more groups of interdependent hardware peripherals and repeat the procedure until all combinations of groups are power measured. Then, select the combination of groups that have the least power consumption.

Thereafter, at step 508, the method 500 may include generating a file with the load region and the execution regions defined for the subset. In some example embodiments, the generation module 416 may create the file based on the created subset from among the one or more groups of interdependent hardware peripherals. Then, the generation module 416 may store the generated file in the XRAM. At the time of warm boot, the SoC 301 may use the XRAM to initialize the interdependent hardware peripherals by executing the file stored in the XRAM. The initialization of the interdependent hardware peripherals may occur simultaneously with the memory configuration and calibration of the DRAM, thereby optimizing (or improving) the power consumption in the SoC during the warm boot.

FIGS. 6A-6B illustrate an operational flow for optimizing (or improving) power consumption in the SoC during warm boot, in accordance with some example embodiments. In some example embodiments, the SoC 301 initialization sequence (e.g., the cold and the warm boot) architecture may use an extended random-access memory (XRAM) to initialize the hardware peripherals 610-612. It should be noted that the architecture of the SoC referred to in FIGS. 6A-6B may be similar to the SoC 301 defined in FIG. 3. Hence, similar features are not described again for the sake of brevity. In some example embodiments, the hardware peripherals 610-612 may be initialized (also referred to by “Init”) by executing an initial real-time processor unit (RPU) code, e.g., the file generated at step 508 of method 500, from the XRAM simultaneously with the memory configuration and calibration of the DRAM. As shown in FIG. 6A, the SoC initialization sequence (e.g., the cold boot and the warm boot) may include cold boot-up stages and warm boot stages. In the cold boot-up stage 602 (also referred to as stage 1), a power management controller (PMC) may start executing boot ROM. e.g., power on reset. In the cold boot-up stage 604 (also referred to as stage 2), the power management controller (PMC) may load platform firmware into a peripheral protection unit (PPU) random-access memory (RAM). In the cold boot-up stage 606 (also referred to as stage 3), the PMC may perform network-on-chip (NoC) and a double data rate (DDR) configuration and reset the RPU. The RPU booting may be completed (or may be completed fast or faster) and a deep sleep state early (or a deep sleep state may occur early). As shown in FIG. 6A, the RPU may initialize the hardware peripherals 610-612 from the XRAM while the completion of NoC and the DDR interface initialization is ongoing. The RPU may run (or the RPU may perform, or the RPU may typically run) a customized real-time operating system (RTOS) such as a Free RTOS to support fast (or faster) interrupt processing (of the SoC). Further, as the XRAM is in the always-ON domain (or in the ON domain), the XRAM may retain power when the SoC 301 goes into deep sleep. Thus, the generated file (e.g., the file generated at step 508 of method 500) is loaded to the XRAM using a scatter load mechanism. The scatter load mechanism may be a feature from a linker that prepares a binary with different load and execution regions. With the scatter load mechanism, the generated file (e.g., the file generated at step 508 of method 500) can be loaded into the XRAM during cold boot once (or only once). Therefore, by using the scatter load mechanism, there may be no need to load code from an external DRAM into the XRAM when the SoC 301 wakes up from deep sleep during the warm boot (or by using the scatter load mechanism, code from an external DRAM may not be loaded into the XRAM when the SoC 301 wakes up from deep sleep during the warm boot). With the XRAM implementation, the waiting time for DDR interface initialization may be leveraged (or may be used) by the RPU to reduce its initialization time, by pre-configuring the hardware peripherals 610-612 in advance. This approach reduces the SoC 301 initialization time duration during the warm boot.

Accordingly, the present inventive concepts provide techniques for optimizing (or improving) power consumption in the SoC 301 during the warm boot.

Further, the disclosed techniques provide various advantages. For example, the disclosed techniques optimize (or improve) the size (or the required size) of XRAM in the SoC 301 and the functions that can be hosted on XRAM, based on DRAM initialization time. The disclosed techniques reduce the total response time and power consumption during periodic warm boot sequences. The disclosed techniques result in an improvement in battery life, increasing the device's day of use (DOU) (e.g., increasing a period of time the device can operate within a day (24-hour period) without requiring a recharge (or without depleting the charge of the battery of the device)).

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FGPA), a System-on-Chip (SoC), a programmable logic unit, a microprocessor, application-specific integrated circuit (ASIC), etc.

Any or all of the elements described with reference to FIGS. 4 and 6A-6B may communicate with any or all other elements described with reference to FIG. 4 and 6A-6B. For example, any element may engage in one-way and/or two-way and/or broadcast communication with any or all other elements in FIGS. 4 and 6A-6B, to transfer and/or exchange and/or receive information such as but not limited to data and/or commands, in a manner such as in a serial and/or parallel manner, via a bus such as a wireless and/or a wired bus (not illustrated). The information may be in encoded in various formats, such as in an analog format and/or in a digital format.

While specific language has been used to describe the disclosure, any or some limitations arising out of the language used may not be intended. As would be apparent to a person in the art, various working modifications may be made to the method in order to implement the inventive concepts as taught herein.

The drawings and the forgoing description give examples of some example embodiments. Those skilled in the art will appreciate that one or more of the described elements may well be combined into a single functional element. Alternatively, certain elements may be split into multiple functional elements. Elements from one example embodiment may be added to another example embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of some example embodiments is by no means limited by these specific examples embodiments. Numerous variations, whether explicitly given in the specification or not, such as differences in structure, dimension, and use of material, are possible. The scope of example embodiments is at least as broad as given by the following claims.

Benefits, other advantages, and solutions to problems have been described above with regard to some example embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for optimizing power consumption in a system on chip (SoC) during warm boot, the method comprising:
identifying one or more groups of interdependent hardware peripherals on the SoC, wherein an interdependency among at least two interdependent hardware peripherals within each group of the one or more groups of interdependent hardware peripherals corresponds to an initialization sequence of the at least two interdependent hardware peripherals;
determining power consumed by the one or more groups of interdependent hardware peripherals during the warm boot of the SoC;
creating a subset from among the one or more groups of interdependent hardware peripherals, wherein the power consumed during the warm boot by the one or more groups of interdependent hardware peripherals in the subset is below a power consumption threshold; and
generating, based on the subset from among the one or more groups of interdependent hardware peripherals, a file with a load region and an execution region for the subset.

2. The method of claim 1, wherein the identifying the one or more groups of interdependent hardware peripherals comprises:
determining one or more initialization sequences of the at least two interdependent hardware peripherals;
determining an initialization time for initializing the at least two interdependent hardware peripherals in each initialization sequence of the one or more initialization sequences; and
identifying the one or more groups of interdependent hardware peripherals, wherein the initialization time for initializing the at least two interdependent hardware peripherals in the one or more groups of interdependent hardware peripherals is below a initialization time associated with initialization of a dynamic random-access memory (DRAM).

3. The method of claim 1, wherein the identifying the one or more groups of interdependent hardware peripherals comprises:
identifying one or more independent hardware peripherals, wherein the one or more independent hardware peripherals are configured to be initialized in an independent manner; and
identifying the one or more groups of interdependent hardware peripherals in response to excluding the identified one or more independent hardware peripherals.

4. The method of claim 1, wherein the determining the power consumed by the one or more groups of interdependent hardware peripherals comprises:
determining the power consumed corresponding to one of
each group of the one or more groups of interdependent hardware peripherals; or
a combination of groups of the one or more groups of interdependent hardware peripherals in an optimized sequence.

5. The method of claim 1, wherein the creating the subset from among the one or more groups of interdependent hardware peripherals comprises:
creating an intermediate file with the load region and the execution region, wherein the execution region includes an initialization sequence of one of
each group of the one or more groups of interdependent hardware peripherals; or
a combination of groups of the one or more groups of interdependent hardware peripherals;
generating a binary file corresponding to the intermediate file;
determining, based on execution of the binary file, the power consumed by initializing the at least two interdependent hardware peripherals with respect to the initialization sequence; and
creating the subset corresponding to one of
each group of the one or more groups of interdependent hardware peripherals; or
the combination of groups of the one or more groups of interdependent hardware peripherals,
wherein the power consumed during the warm boot by one of each group of the one or more groups of interdependent hardware peripherals, or the combination of groups of the one or more groups of interdependent hardware peripherals is below the power consumption threshold.

6. The method of claim 1, wherein the load region corresponds to DRAM, and the execution region corresponds to an extended random-access memory (XRAM).

7. A system for optimizing power consumption in a system on chip (SoC) during warm boot, the system comprising:
a memory storing a program of instructions;
a processor coupled with the memory;
a power management unit coupled to the memory and the processor. wherein the processor is configured to execute the program of instructions to
identify one or more groups of interdependent hardware peripherals on the SoC, wherein an interdependency among at least two interdependent hardware peripherals within each group of the one or more groups of interdependent hardware peripherals corresponds to an initialization sequence of the at least two interdependent hardware peripherals;
wherein the power management unit is configured to determine power consumed by the one or more groups of interdependent hardware peripherals during the warm boot of the SoC;
wherein the processor is further configured to
create a subset from among the one or more groups of interdependent hardware peripherals, wherein the power consumed during the warm boot by the at least two interdependent hardware peripherals in the subset is below a power consumption threshold; and
generate, based on the subset from among the one or more groups of interdependent hardware peripherals, a file with a load region and an execution region for the subset.

8. The system of claim 7, wherein to identify the one or more groups of interdependent hardware peripherals on the SoC, the processor is configured to:
determine one or more initialization sequences of the at least two interdependent hardware peripherals;
determine an initialization time for initializing the at least two interdependent hardware peripherals in each initialization sequence of the one or more initialization sequences; and
identify the one or more groups of interdependent hardware peripherals, wherein the initialization time for initializing the at least two interdependent hardware peripherals in the one or more groups of interdependent hardware peripherals is below a initialization time associated with initialization of a dynamic random-access memory (DRAM).

9. The system of claim 7, wherein to identify the one or more groups of interdependent hardware peripherals on the SoC, the processor is configured to:
identify one or more independent hardware peripherals, wherein the one or more independent hardware peripherals are configured to be initialized in an independent manner; and
identify the one or more groups of interdependent hardware peripherals in response to excluding the identified one or more independent hardware peripherals.

10. The system of claim 7, wherein for determining the power consumed by the one or more groups of interdependent hardware peripherals, the power management unit is configured to:
determine the power consumed corresponding to one of
each group of the one or more groups of interdependent hardware peripherals; or
a combination of groups of the one or more groups of interdependent hardware peripherals in an optimized sequence.

11. The system of claim 7, wherein for creating the subset from among the one or more groups of interdependent hardware peripherals, the processor is configured to:
create an intermediate file with the load region and the execution region, wherein the execution region comprise an initialization sequence of one of
each group of the one or more groups of interdependent hardware peripherals; or
a combination of groups of the one or more groups of interdependent hardware peripherals;
generate a binary file corresponding to the intermediate file;
determine, based on execution of the binary file, the power consumed by initializing the at least two interdependent hardware peripherals with respect to the initialization sequence; and
create the subset corresponding to one of
each group of the one or more groups of interdependent hardware peripherals; or
the combination of groups of the one or more groups of interdependent hardware peripherals,
wherein the power consumed during the warm boot by one of each group of the one or more groups of interdependent hardware peripherals, or the combination of groups of the one or more groups of interdependent hardware peripherals is below the power consumption threshold.

12. The system of claim 7, wherein the load region corresponds to DRAM, and the execution region corresponds to an extended random-access memory (XRAM).

13. The method of claim 1, further comprising:
storing the file in an extended random-access memory (XRAM); and
initializing the at least two interdependent hardware peripherals by executing the file stored in the XRAM.

14. The method of claim 13, wherein the initialization of the at least two interdependent hardware peripherals occurs simultaneously with memory configuration and calibration of a dynamic random-access memory (DRAM).

15. The system of claim 7, wherein the processor is further configured to
store the file in an extended random-access memory (XRAM); and
initializing the at least two interdependent hardware peripherals by executing the file stored in the XRAM.

16. The system of claim 15, wherein the initialization of the at least two interdependent hardware peripherals occurs simultaneously with memory configuration and calibration of a dynamic random-access memory (DRAM).

17. A method of an initialization sequence of a system on chip (SoC), the method comprising:
executing, by a power management controller (PMC), a boot read-only memory (ROM) power on reset;
loading, by the PMC, platform firmware into a peripheral protection unit (PPU) random-access memory (RAM); and
performing, by the PMC, a network-on-chip (NoC) and a double data rate (DDR) configuration and a reset of a real-time processor unit (RPU).

18. The method of claim 17, further comprising:
initializing, by the RPU, one or more interdependent hardware peripherals from an extended random-access memory (XRAM) while a completion of the NoC and the DDR is ongoing,
performing, by the RPU, a customized real-time operating system (RTOS) to support an interrupt processing; and
loading a file to the XRAM using a scatter load mechanism.

19. The method of claim 18, wherein the file is loaded to the XRAM during a cold boot of the SoC.

20. The method of claim 19, wherein the file includes a load region and an execution region corresponding to a subset of the one or more groups of interdependent hardware peripherals of the SoC.
